(19) United States
(12) Patent Application Publication
(10) Pub. No.: US 2018/0249276 A1
(43) Pub. Date: Aug. 30, 2018

(54) SYSTEM AND METHOD FOR REPRODUCING THREE-DIMENSIONAL AUDIO WITH A SELECTABLE PERSPECTIVE

(71) Applicant: RISING SUN PRODUCTIONS LIMITED, TORONTO (CA)

(72) Inventor: MICHAEL GODFREY, TORONTO (CA)

(21) Appl. No.: 15/758,483

(22) PCT Filed: Sep. 16, 2016
(86) PCT No.: PCT/CA2016/051090

§ 371 Date: Mar. 8, 2018

Related U.S. Application Data
(60) Provisional application No. 62/219,389, filed on Sep. 16, 2015.

(51) Int. Cl. H04S 7/00; H04R 3/00; H04R 5/027; H04R 1/40; H04N 5/232; H04N 5/247

(52) U.S. Cl. CPC H04S 7/303; H04R 3/005; H04R 5/027; H04S 2400/15; H04N 5/23238; H04N 5/247; H04R 1/406

(57) ABSTRACT

A system and method for capturing and recording audio suitable for subsequent reproduction in a 360 degree, virtual and augmented reality environment is described. It includes recording audio input from a plurality of audio sensors arranged in a three-dimensional space; and for each of the audio sensors, associating and storing position information with the recorded audio input which corresponds to the position of the audio sensors in the three-dimensional space and associating and storing direction information with the recorded audio input which corresponds to the direction from which the recorded audio has been received.

### FIELD OF THE INVENTION

The present invention relates to a method and system for creating virtual and augmented reality immersive recordings and reproductions. More particularly, the present invention relates to an audio processing system that may be combined with video recording for creating 360 degree, virtual and augmented reality recordings and reproductions.

### BACKGROUND OF THE INVENTION

Camera systems are known in the art that capture multiple viewing directions simultaneously which, after processing, create an environment that when viewed, equates to creating an immersive multidirectional visual experience for the viewer. These camera arrays provide three-dimensional visual coverage of an event and either capture the incoming video signals for further manipulation and processing or directly transmit the information captured for viewing in real time. However, the audio capturing method for these arrays is highly limited and cannot effectively reproduce audio in a three-dimensional virtual environment in the same manner they produce video in a three-dimensional virtual environment.

Knowing that we as humans localize audio via binary localization, which is the ability of the brain to determine the position of sound sources in a three-dimensional environment, the limitations of prior systems play havoc on the potential processing of audio captured in accordance with pre-existing systems and its corresponding sense of re-created reality in its final delivered form. Audio interpretation is a very powerful sense to humans. Its function in our physiology relates to both balance and body location in three-dimensional reality as well as basic hearing functions. Changing the view or perspectives of video while having the audio not correctly spatially configured or matching the video to the audio in a way that makes sense in orientation may only confuse the viewer and/or listener. Imagine the confusion encountered by capturing the audio for a forward perspective video shot and then physically turning around 180 degrees backwards in three-dimensions and the audio is still playing back from the forward perspective. The re-created space would appear backwards to the viewer and/or listener and would not achieve the intended goal of conveying an accurate three-dimensional representation of the initially captured event or space.

Accordingly, there remains a need for improvements in the art. In particular, there is a need a system and method of creating three-dimensional, perspective-based audio that works correctly with the three-dimensional, perspective-based video offered by immersive or other multi-camera arrays.

### SUMMARY OF THE INVENTION

In accordance with an aspect of the invention, there is provided a method for capturing and recording audio suitable for subsequent reproduction in a virtual reality environment, the method comprising: recording audio input from a plurality of audio sensors arranged in a three-dimensional space; and for each of the audio sensors, associating and storing spatial position information with the recorded audio input which corresponds to the position of the audio sensors in the three-dimensional space to create at least one audio recording.

According to an embodiment of the invention, the method further provides for associating the recorded audio input from the plurality of audio sensors with recorded video input from at least one video camera such that the recorded audio input may be synchronized in time with the recorded video input.

According to a further embodiment, the present invention further includes receiving information identifying a listener's head position and head orientation in a three-dimensional space; processing the at least one audio recording, in which the processing comprises, for each of the listener's left ear and the listener's right ear, synthesizing audio that corresponds to the audio the listener's ears would be receiving from the at least one audio recording at the listener's head position and head orientation in the three-dimensional space; and outputting the synthesized audio to the listener's left ear and the listener's right ear through at least one audio playback device support.

According to a further embodiment, the present invention provides a system for recording audio suitable for subsequent reproduction in a virtual realty environment, the system comprising: a plurality of audio sensors arranged in a three-dimensional space, each audio sensor for receiving audio input; a processor for executing computer-readable instructions which when executed, cause the processor to receive and store the received audio from any of the plurality of audio sensors as at least one audio recording, and for each audio recording, cause the processor to associate and store position information which corresponds to the position of the audio sensor in the three-dimensional space, and associate and store direction information which corresponds to the direction from which the recorded audio has been received.

According to a still further embodiment, the present invention provides a system for reproducing audio in a virtual reality environment, the system comprising: at least one audio playback device capable of generating sound from synthesized audio; a processor for executing computer-readable instructions which when executed, cause the processor to: receive information identifying a listener's head position and head orientation in a three-dimensional space; process one or more audio recordings each having associated position information which corresponds to the position the audio was recorded from in the three-dimensional space and associated direction information which corresponds to the direction from which the recorded audio was received, in which the processing comprises, for each of the listener's left ear and the listener's right ear, synthesizing audio corresponding to audio that the listener's ears would receive from the one or more audio recordings at the listener's head position and head orientation in the three-dimensional space; and outputting the synthesized audio to the listener's left ear and the listener's right ear through the at least one audio playback device.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a schematic of a system for recording and reproducing audio within a three-dimensional space according to an embodiment of the present invention;

FIG. 2 is a front perspective view of a schematic representation of an audio sensor array in accordance with an embodiment of the present invention;

FIG. 3 is a top view of the audio sensor array shown in FIG. 2;

FIG. 4 is a bottom view of the audio sensor array shown in FIG. 2;

FIG. 5 is a back view of the audio sensor array shown in FIG. 2;

FIG. 6 is a schematic showing the system from the audio sensor array to the mixing matrix and the virtual reality production system according to an embodiment of the present invention;

FIG. 6b is a further embodiment of a system from the audio sensor array to the mixing matrix and the virtual reality production system;

FIG. 7 is a front perspective view of a frame integrating video and audio arrays for utilization in conjunction with an embodiment of the present invention;

FIG. 8 is a perspective view from an opposite direction than that shown in FIG. 7;

FIG. 9 is a perspective view of a sixteen-camera/audio sensor array in accordance with an embodiment of the present invention;

FIG. 10 is a side view of an exemplary video camera for use with an embodiment of the present invention;

FIG. 11 is a side view of an exemplary spherical video camera assembly for use with an embodiment of the present invention;

FIG. 12 is a lower perspective view of an exemplary hemispherical video camera assembly for use with an embodiment of the present invention;

FIG. 13 is a side view of an exemplary hemispherical video camera assembly for use with an embodiment of the present invention;

FIG. 14 is a side view of an exemplary spherical video camera assembly for use with an embodiment of the present invention;

FIG. 15 is a side view of an exemplary hemispherical video camera assembly for use with an embodiment of the present invention;

FIG. 16 is a side view of an exemplary 360-degree video camera assembly for use with an embodiment of the present invention; and

FIG. 17 shows an audio matrix according to an embodiment of the present invention.

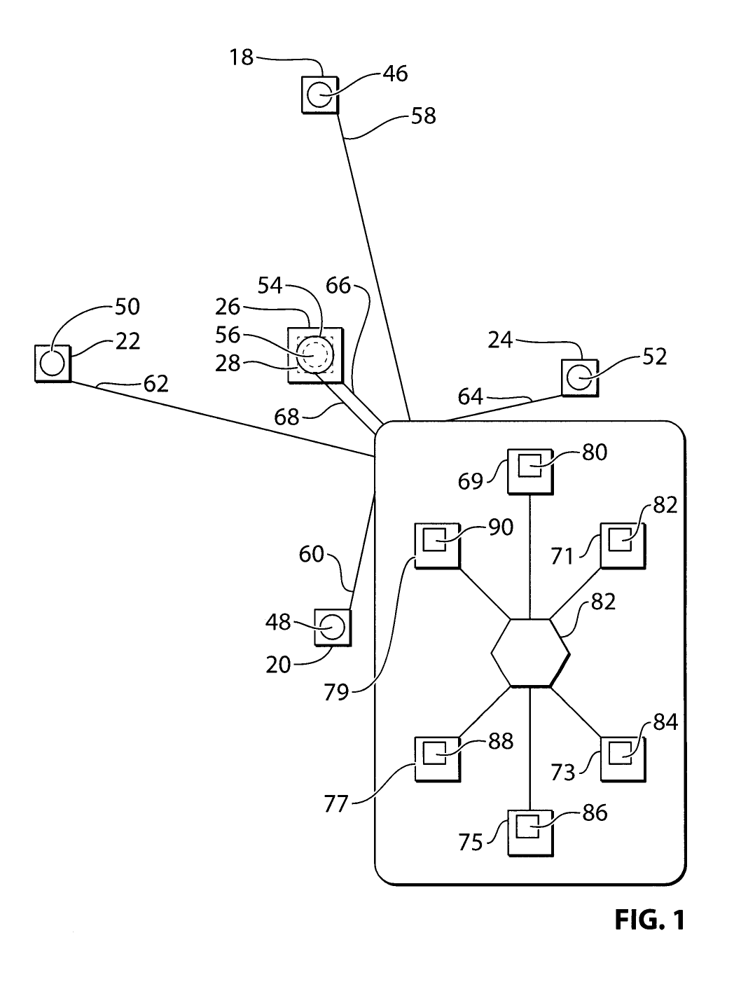

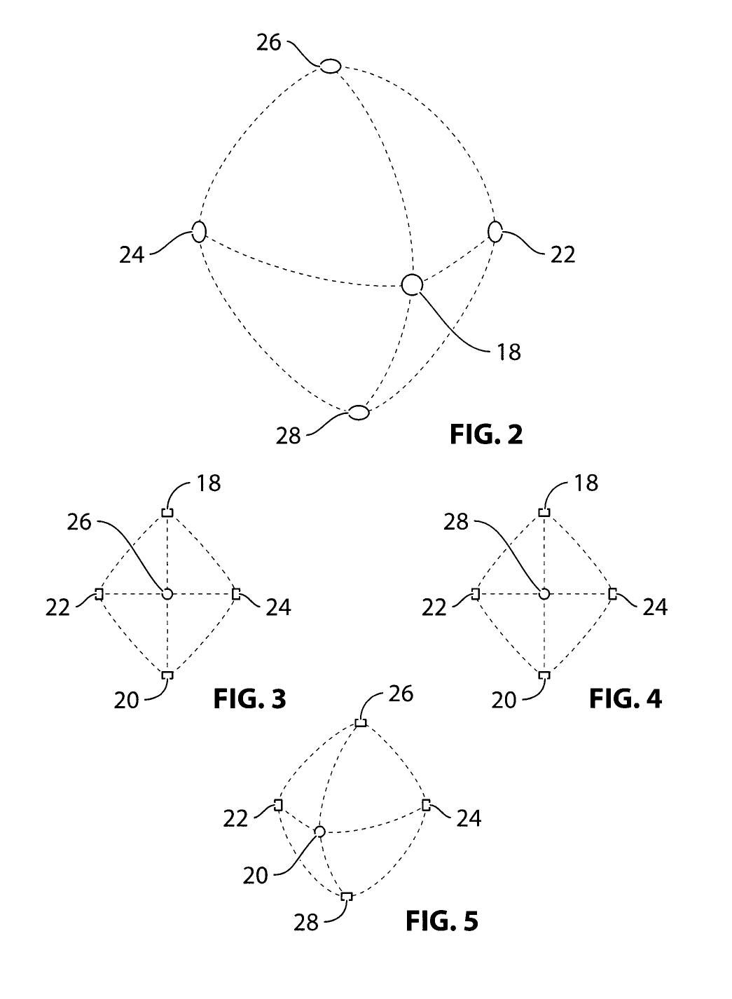

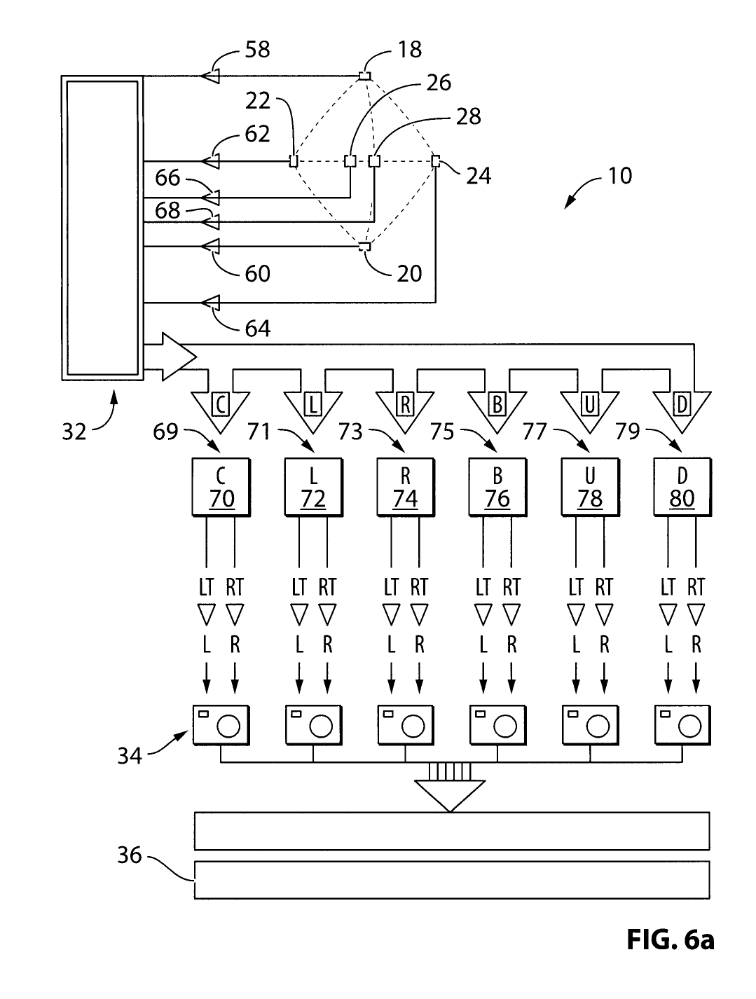

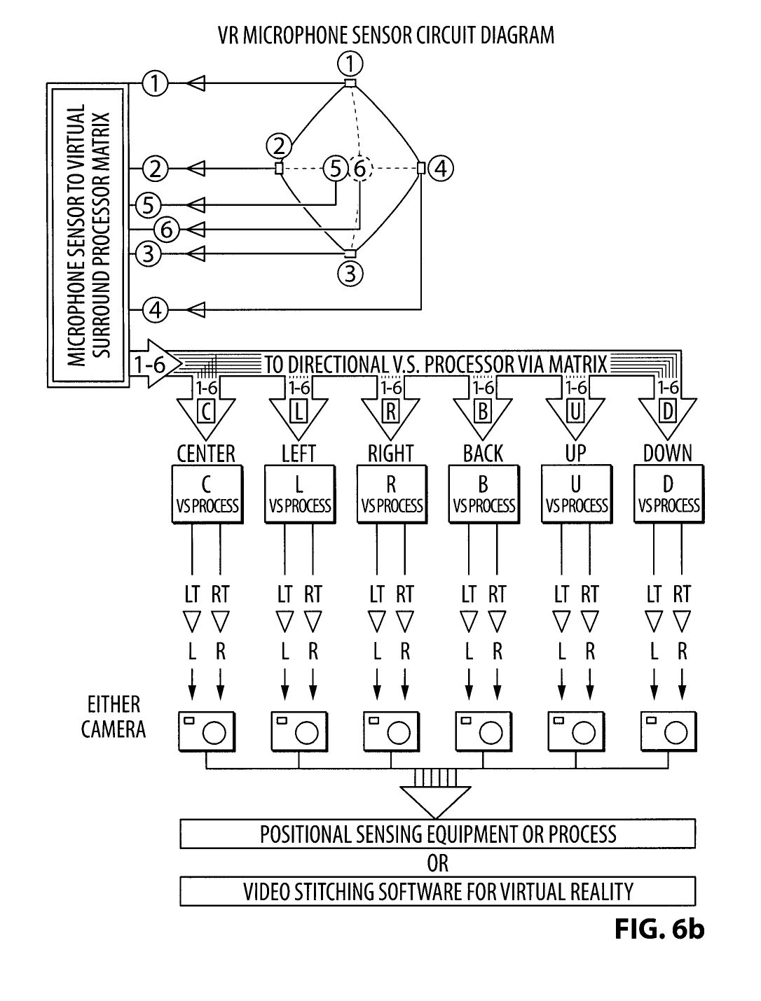

Like reference numerals indicate like or corresponding elements in the drawings.

### DETAILED DESCRIPTION OF THE EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and use the invention.

Referring to the various figures, a system and method for recording and reproducing audio within a three-dimensional space defined by an X-axis, a Y-axis, and a Z-axis for full three-dimensional virtual reality production is disclosed. As will be appreciated based upon the following disclosure, the present 360 degree, virtual and augmented reality recording and reproducing system 10 includes an audio capture system capable of recording audio within a full three-dimensional space. The recorded audio is linked to video of a full three-dimensional space for producing a complete 360 degree, virtual and augmented reality experience when the audio and video are reproduced using a 360 degree, virtual and augmented reality production system 36.

The present virtual reality recording and reproducing system 10 recreates audio in three-dimensions no matter which perspective a viewer chooses to view in a three-dimensional visual virtual reality production and maintains the audio perspective in the same perspective as the video. The virtual reality recording and reproducing system 10 keeps the entire three-dimensional production, transmission or recording intact and in correct three-dimensional perspective in relation to each other.

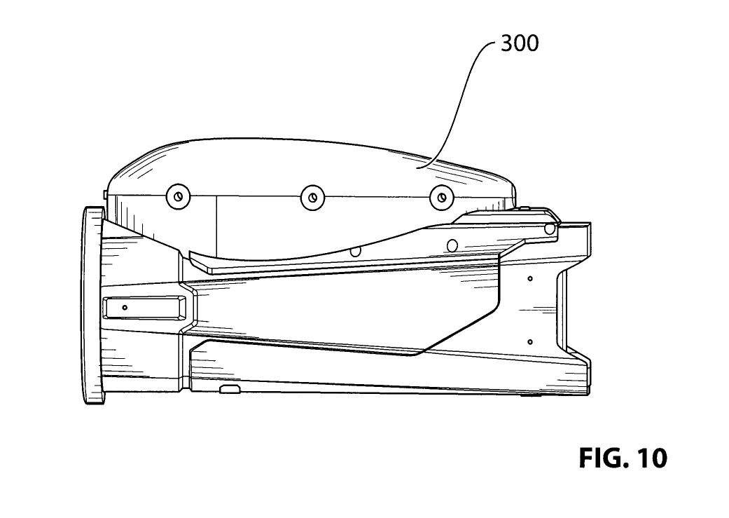

In this embodiment, the virtual reality recording and reproducing system 10 includes a multi-directional array of audio sensors 18, 20, 22, 24, 26, 28, for example, microphones, including a mounting frame 16 supporting a plurality of audio sensors situated surrounding a central position. The multi-directional array of audio sensors 18, 20, 22, 24, 26, 28 may include a first plurality of audio sensors 18, 20 oriented to receive sound along the X-axis of the mounting frame 16, a second plurality of audio sensors 22, 24 oriented to receive sound along the Y-axis of the mounting frame 16, and a third plurality of audio sensors 26, 28 oriented to receive sound within the Z-axis of the mounting frame 16. The multi-directional array of audio sensors 18, 20, 22, 24, 26, 28 may be aligned with a similarly oriented array of cameras 46, 48, 50, 52, 54, 56. There are cameras, such as those available from Vantrix Corporation, that capture the immersive video according to techniques known in the art with as few as a single lens, and each camera may have at least one associated audio sensor. An exemplary single-lens camera 300 is shown in FIG. 10.

The 360 degree, virtual and augmented reality recording and reproducing system 10 may also include a mixing matrix 32 in communication with the multi-directional array of audio sensors 18, 20, 22, 24, 26, 28 and the directional array of cameras 46, 48, 50, 52, 54, 56. The mixing matrix 32 combines sound and positional information from each audio sensor 18, 20, 22, 24,26, 28 to create a stored audio matrix 34. Thus, each audio sensor 18, 20, 22, 24,26, 28 may have associated positional and directional information that is stored and combined with the audio information from the audio sensor 18, 20, 22, 24,26, 28. There may also be a processor or mixer or similar means to combine the matrixed audio signals with a video signal. While a preferred embodiment of the present invention combines the audio and video feeds, it is appreciated the multi-channel audio channels created by the present virtual reality recording and reproducing system 10 may remain discrete throughout the production and post production process used in the creation of virtual reality or three-dimensional video. For example, in a security related production the operator of these processes may have a choice as to which audio perspective and visual perspective they would like to use at any given time for the benefit of the operator or the desired outcome.

Finally, the 360 degree, virtual and augmented reality recording and reproducing system 10 may include a virtual reality production system 36 for creating a virtual three-dimensional audio and video environment for an individual based upon the positional information of the virtual reality production system 36 and the stored audio matrix 34. Complete three-dimensional virtual reality requires the synchronized presentation of both audio and video with consideration of the individual's head position and the perceived location from which sound emanates. As such, video information is linked with the audio information, generated in accordance with the present invention, such that the ultimately virtual reality production system may combine the audio and video information to create virtual reality.

It is appreciated that there are immersive audio systems in the art that can already include audio information to be carried simultaneously with the video information being experienced by a user. Programming methods used to implement the experience such as UNITY create a video “sphere” around a user from which the user can select, via sensor located in a head-worn viewing apparatus, which direction he or she faces in space. Within the development stage of the UNITY program there is means already for inputting audio data to be experienced in specified locations in the created space. These elements are created only in stereo or monophonically and placed in near or far space in relation to the viewer. If the data was captured correctly in accordance and utilizing my invention and summarily treated three-dimensionally instead of by individual audio objects, the final experience will be a much more accurate and believable depiction of a re-created scene. This can be done within this invention by capturing properly and setting the spatial coordinates within the program that approximate the physical location of this inventions microphone apparatus elements and their spatial relation to the actual viewer's head. This matrixed audio, captured properly and now inserted with spatial correctness inside the program, would now be available simultaneously with the selectable video and would operate in tandem- to piggyback on the existing video matrix already present in the program.

It is also appreciated video stitching and editing systems for video virtual reality systems are known and may be employed in accordance with the present invention. For example, systems such as KOLOR™—www.kolor.com already have means for dealing with the multi-perspective video related to virtual reality production. Such systems employ a type of video stitching software. In accordance with the present invention, the stitch editing software may be provided with a number of individual audio or audio/video (audio combined with video) tracks containing the perspective-based audio signals. As such, an operator of the virtual reality stitching editing equipment may have the ability to lay in the audio track as they see fit depending on which perspective information they choose. The same goes for operators of security equipment; that is, they may choose which perspective-based audio channel to listen to by switching cameras and the resulting view perspectives.

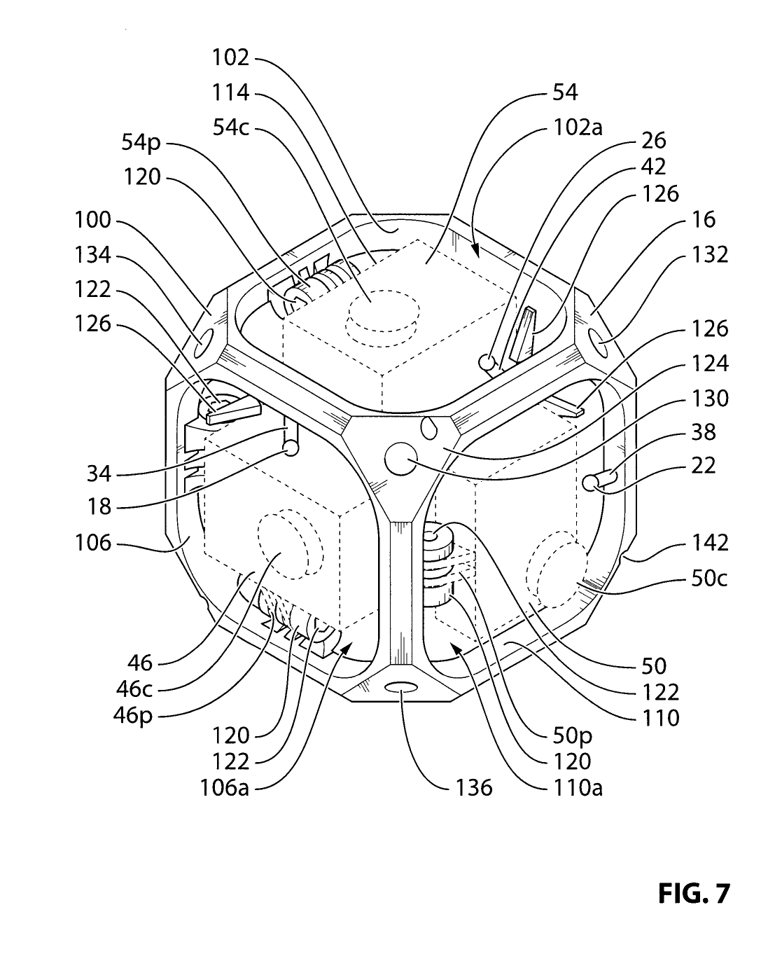

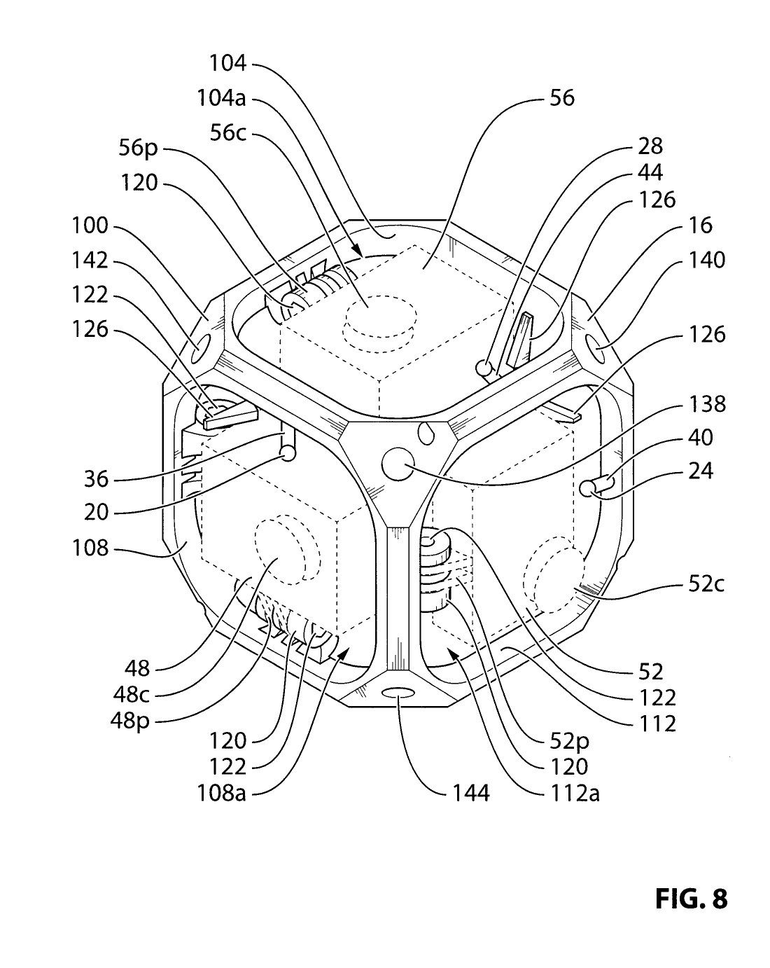

Considering first the multi-directional array of audio sensors 14, the multi-directional array of audio sensors 14 may include a mounting frame 16 supporting the plurality of audio sensors 18, 20, 22, 24, 26, 28. The mounting frame 16 extends in a three-dimensional space and as such extends along an X-axis, a Y-axis and a Z-axis. While it is appreciated the mounting frame 16 may move physically within the three-dimensional space being captured during use, the conventional direction of the X-axis, the Y-axis and the Z-axis in which the mounting frame 16 lies as described herein refers to the directions when mounting frame 16 sitting upon a horizontal support surface as shown with reference to FIGS. 7 and 8.

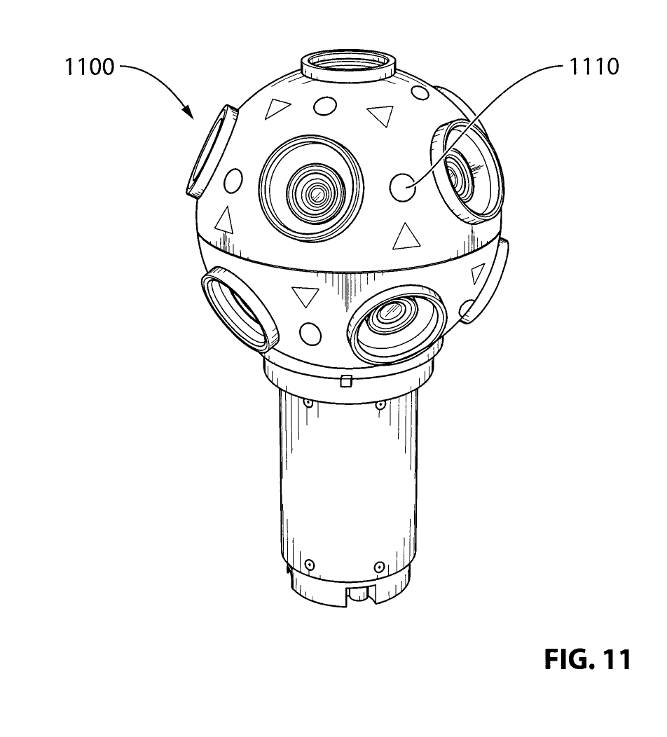

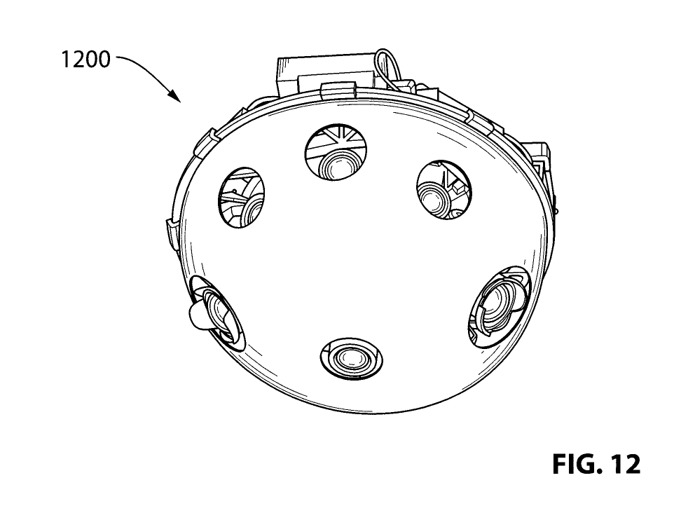

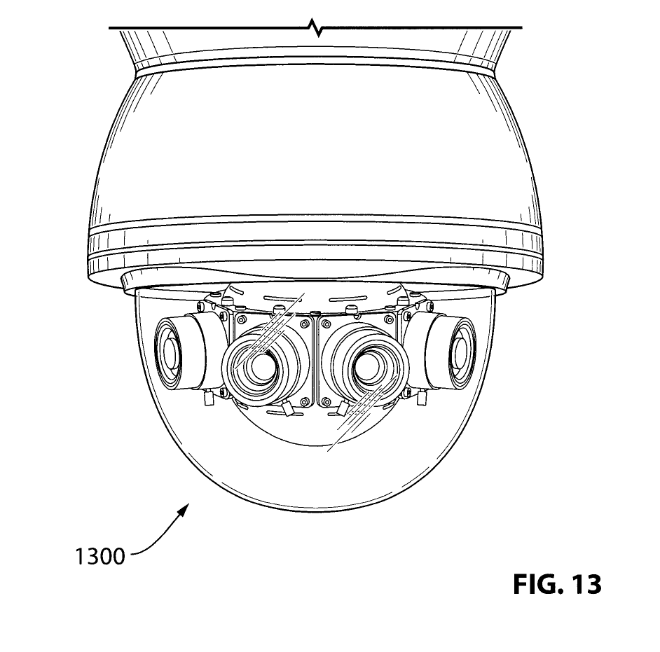

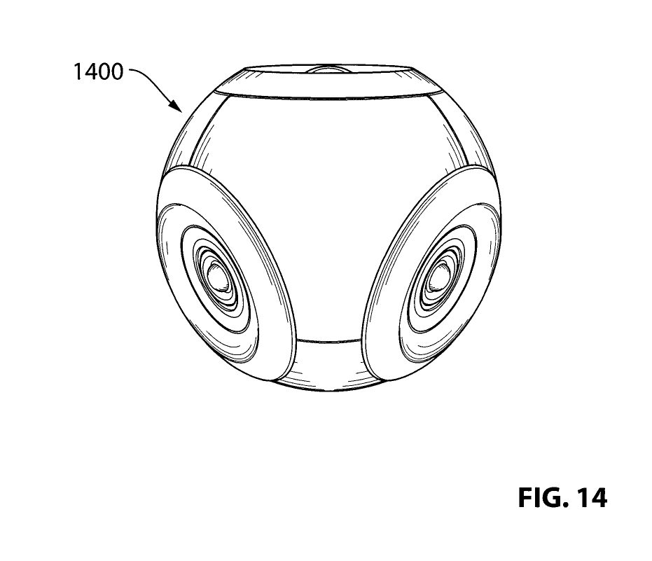

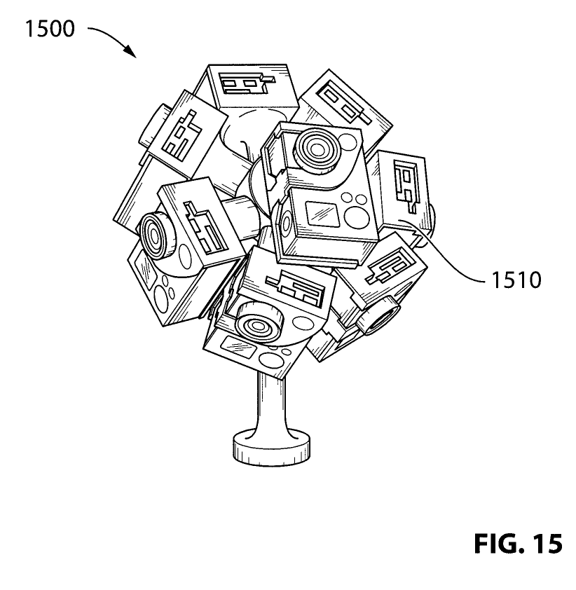

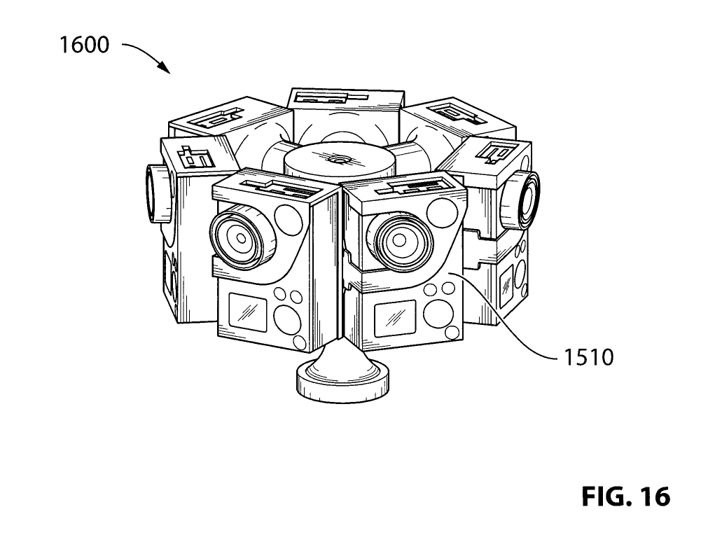

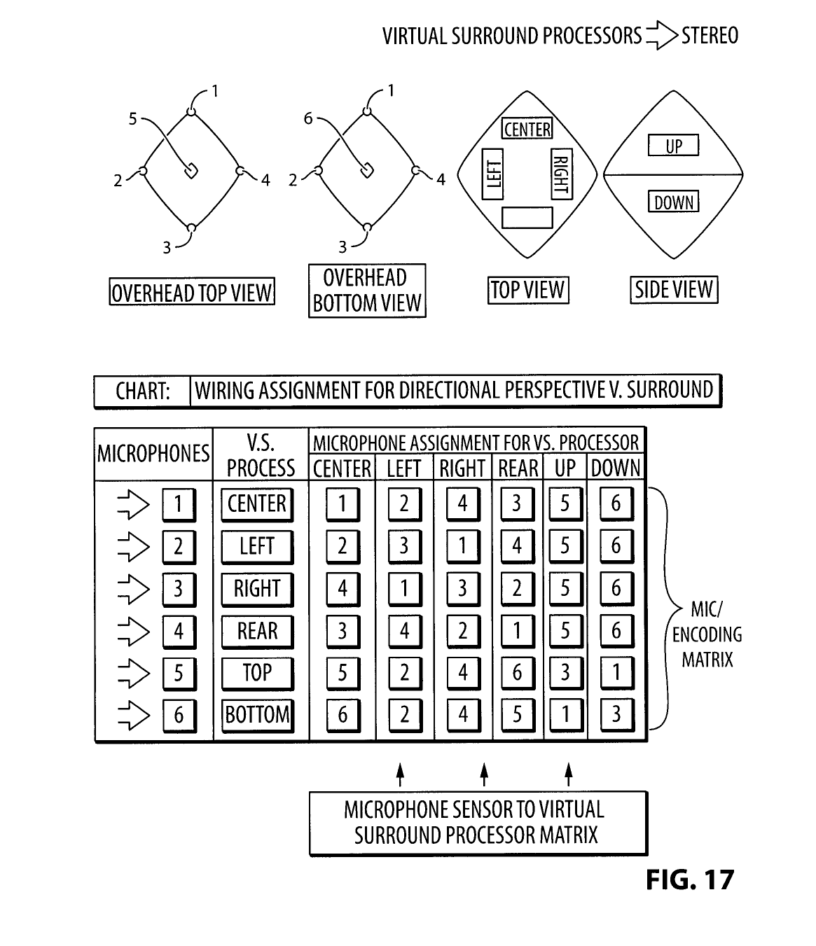

It is appreciated a variety of mounting frame structures may be employed in accordance with the present invention. Spherical frames 1100, such as shown in FIG. 11, along with potential audio sensor locations 1110 may be used. FIG. 14 shows a variant 1400 of a spherical frame. Alternatively, hemispherical frames 1200, 1300, common in security applications, and as shown in FIGS. 12 and 13 may be used. Additionally, hemispherical frames 1500 or 360-degree frames 1600 may be made from assembling individual cameras 1510 together, as shown in FIGS. 15 and 16. The frames shown and described herein are meant to be illustrative and not limiting in respect of the present invention.

For the non-limiting purposes of the present description, one such mounting frame structure as disclosed in U.S. Patent Application Publication No. 2014/0267596, entitled “CAMERA SYSTEM,” published Sep. 18, 2014. The mounting frame disclosed in the '596 publication is designed for supporting multiple video cameras in a three dimensional array, but, and as explained below, may be readily adapted for use in conjunction with the present invention. While it is appreciated that the audio sensors may be attached to the mounting frame being used to support the array of cameras, it is also appreciated the audio sensors of the present invention may be supported on a separate stand or the audio sensors may be integrated with the cameras.

Accordingly, and with reference to FIGS. 7 and 8, the mounting frame 16 in accordance with a preferred embodiment may include an external support structure 100 having six perpendicularly oriented mounting panels 102, 104, 106, 108, 110, 112 in which individual digital cameras 46, 48, 50, 52, 54, 56 may be mounted. As shown, the mounting panels 102, 104, 106, 108, 110, 112 are connected along their respective edges to form the entirety of the external support structure 100. This configuration allows the use of the water-proof housings 114 provided with various portable cameras, for example, the GoPro® Hero® Series or another suitable camera. The individual cameras 46, 48, 50, 52, 54, 56 are mounted so as to face and extend along the X-axis, the Y-axis, and the Z-axis. Each of the mounting panels 102, 104, 106, 108, 110, 112 may have an opening 102a, 104a, 106a, 108a, 110a, 112a to allow the lens 46c, 48c, 50c, 52c, 54c, 56c of the camera to image the surrounding environment, protect internal components from the environment, and may contain or support additional components. Each of cameras 46, 48, 50, 52, 54, 56 may be identical to each other or be different from each other. Each of the cameras 46, 48, 50, 52, 54, 56 may be fixed in a 90-degree alternating orientation relative to the next mounting panel 102, 104, 106, 108, 110, 112, so that the optical centers of each lens 46c, 48c, 50c, 52c, 54c, 56c of the cameras 46, 48, 50, 52, 54, 56 are at a minimum distance from the common optical center of the complete rig.

Attachments are achieved by securing prongs 46p, 48p, 50p, 52p, 54p, 56p of cameras 46, 48, 50, 52, 54, 56 (in particular, the waterproof housings 114 of the cameras 46, 48, 50, 52, 54, 56) into the three prong holder 120 with a hex cap screw and a hex nut clamping to secure the cameras to the prong holder 120. Two additional holders 126 may be used to prevent additional movement of each camera, to adjust the prong-holder 120 to keep the cameras 46, 48, 50, 52, 54, 56 stable. In at least some configurations, holders 126 may take the form of a holding and release clip.

The external support structure 100 may be provided with various coupling arms 34, 36, 38, 40, 42, 44 to which the audio sensors 18, 20, 22, 24, 26, 28 may be secured such that the audio sensors 18, 20, 22, 24, 26, 28 face in directions corresponding to the cameras, that is, along an X-axis, a Y-axis and a Z-axis. Each of the radially extending coupling arms 34, 36, 38, 40, 42, 44 may couple each of the audio sensor 18, 20, 22, 24, 26, 28 to the support structure 100.

More particularly, first and second X-axis coupling arms 34, 36 may support first and second X-axis audio sensors 18, 20 (that is, a plurality of X-axis audio sensors), first and second Y-axis coupling arms 38, 40 may support first and second Y-axis audio sensors 22, 24 (that is, a plurality of Y-axis audio sensors), and first and second Z-axis coupling arms 42, 44 may support first and second Z-axis audio sensors 26, 28 (that is, a plurality of Z-axis audio sensors), wherein the various coupling arms are oriented perpendicular to each other. It is appreciated the disclosed embodiment includes six audio sensors, but more audio sensors may be integrated into the system wherein such audio sensors might be positioned in axes bisecting the X-axis, Y-axis and Z-axis. For example, and as shown with reference to FIGS. 7 and 8, additional audio sensors 130, 132, 134, 136, 138, 140, 142, 144 may be integrated into the external mounting frame such that they sit at positions where three panels meet to form a corner of the external mounting frame. Such alternative embodiments would similarly require a symmetrical arrangement of audio sensors and support arms so as to ensure the integrity of the sound recorded and reproduced in accordance with the present invention.

As explained above, and in accordance with a preferred embodiment, each set of the audio sensors 18, 20, 22, 24, 26, 28 may be generally aligned with a digital camera lens 46, 48, 50, 52, 54, 56 directed in the same general direction as the audio sensor 18, 20, 22, 24, 26, 28. The mounting frame 16 may also support first and second X-axis cameras 46, 48 aligned with the first and second X-axis audio sensors 18, 20, first and second Y-axis cameras 50, 52 aligned with the first and second Y-axis audio sensors 22, 24, and first and second Z-axis cameras 54, 56 aligned with the first and second Z-axis audio sensors 26, 28. It is contemplated the respective cameras and audio sensors may be constructed as integral units and assembled in accordance with an embodiment of the present invention. As such, the combination of cameras 46, 48, 50, 52, 54, 56 and audio sensors 18, 20, 22, 24, 26, 28 may be considered a directional array of audio and video recorders.

In addition, a single camera lens that captures in a wide angle such as 180 degrees in a field of view may be employed singly or in tandem with another lens to capture 360-degree video footage. These camera systems may also be configured with multiple microphones that capture 360 degrees of sound simultaneously.

The audio sensors 18, 20, 22, 24, 26, 28 and cameras 46, 48, 50, 52, 54, 56 are in communication with the mixing matrix 32 that combines audio, directional and positional information to create stored audio information 34. It is also appreciated the audio information may be processed and stored on its own. As such, an audio-only mixing matrix may be employed in accordance with the present invention or an audio/video matrix may be used.

In one embodiment, it can be manually implemented to set up the microphone channel assignments to configure the positional information. In another embodiment, where the positional information is pre-configured, information is received and the mixing matrix can determine position automatically as long as channel assignments are determined in advance. The mixing matrix 32 may determine audio channel assignments based upon the position of the camera 46, 48, 50, 52, 54, 56 relative to the audio sensors 18, 20, 22, 24, 26, 28 with which the received audio information is associated. The channel assignments may take into account the camera lens direction and sum the independent audio signals derived from the multiple audio sensors into individual sets of “directional units” 69, 71, 73, 75, 77, 79, wherein each directional unit 69, 71, 73, 75, 77, 79 is associated with the view from a specific camera lens.

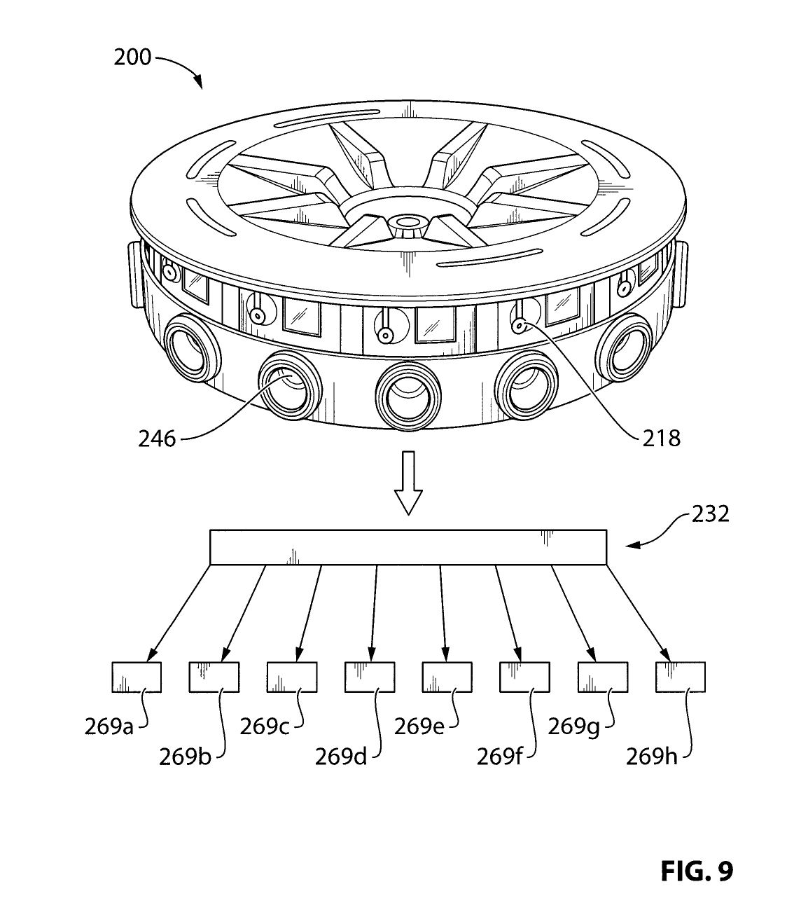

In particular, each directional unit 69, 71, 73, 75, 77, 79 may contain an HRTF (head related transfer function) processor 70, 72, 74, 76, 78, 80 that produces HRTF (head related transfer function) processed multi-channel audio information that corresponds directly with the particular camera lens with which the directional unit 69, 71, 73, 75, 77, 79 is associated. Alternatively, all directional audio units containing the information of multiple microphone perspectives could be run through a single set of HRTF processors after all directional units have been combined in to a single set of multiple audio outputs which consist of all matrixed audio information combined, depending on where in the process it is desirable or practical electronically to be placed. For example, and considering an array of six cameras, there may be six audio “directional units”; if there are four cameras, there are four “directional units”, etc., depending on the view that is required to see either for live audio/video monitoring or after capture for editing/stitching or processing. As shown in FIG. 9, it is contemplated that a sixteen camera unit 200 such as the GoPro® Odyssey Rig may be utilized in conjunction with the present invention wherein sixteen audio sensors 218 are aligned and combined with each of the sixteen cameras 246. Since, for example, the GoPro® Odyssey Rig employs stereoscopic units (that is, two cameras are used for each video image), a mixing matrix 232 of eight directional units 269a-h would be required for processing of the audio produced in accordance with use of such a camera unit 200. In accordance with such an embodiment, it is appreciated that the direction would not be oriented at 90 degree steps, but rather would be oriented at 22.5 degree steps as dictated by the utilization of sixteen cameras equally spaced about a circumferential ring.

It should be appreciated that although each directional unit 69, 71, 73, 75, 77, 79 contains information from multiple audio sensors 18, 20, 22, 24, 26, 28, the audio information from the audio sensors 18, 20, 22, 24, 26, 28 may still be available on multiple independent audio channels which can then be processed by either directional sensors contained in the device or alternatively or additionally by a specific set of stereo HRTF processors or a single stereo Virtual Surround processor assigned to that “directional unit”. There may be simultaneously multiple “directional unit to Virtual Surround” processes going on independently of one another.

In particular, and considering the preferred embodiment described above wherein six cameras 46, 48, 50, 52, 54, 56 and six audio sensors 18, 20, 22, 24, 26, 28 are provided, each camera 46, 48, 50, 52, 54, 56 may be associated with a directional unit 69, 71, 73, 75, 77, 79. As such, first and second X-axis directional units 69, 71 may be associated with first and second X-axis cameras 46, 48, first and second Y-axis directional units 73, 75 may be associated with first and second Y-axis cameras 50, 52, and first and second Z-axis directional units 77, 79 may be associated with first and second Z-axis cameras 54, 56. Each of the first and second X-axis directional units 69, 71, first and second Y-axis directional units 73, 75, and first and second Z-axis directional units 77, 79 may be associated with the complete array of audio sensors 18, 20, 22, 24, 26, 28, although the input of the various audio sensors 18, 20, 22, 24, 26, 28 is processed differently depending upon the camera 46, 48, 50, 52, 54, 56 with which it is associated. For example, and considering the first X-axis directional unit 69 associated with the first X-axis camera 46, the various audio sensors 18, 20, 22, 24, 26, 28 would be processed in the following manner:

first X-axis audio sensor 18—center audio channel;

second X-axis audio sensor 20—rear audio channel;

first Y-axis audio sensor 22—left audio channel;

second Y-axis audio sensor 24—right audio channel;

first Z-axis audio sensor 26—upper audio channel; and

second Z-axis cameras 28—lower audio channel.

Similar channel assignments are provided for the various other directional units depending upon the cameras with which they are associated.

Each of the first and second X-axis directional units 69, 71, first and second Y-axis directional units 73, 75, and first and second Z-axis directional units 77, 79 may include an HRTF (head related transfer function) processor 70, 72, 74, 76, 78, 80 processing the audio from the various audio sensors 18, 20, 22, 24, 26, 28 to produce a sound signal with a three-dimensional sonic picture as described below in greater detail.

In particular, the mixing matrix 32 includes an input 58, 60, 62, 64, 66, 68 connected to the output (not shown) of each of the audio sensors 18, 20, 22, 24, 26, 28. In communication with each of the plurality of inputs 58, 60, 62, 64, 66, 68 is an HRTF (head related transfer function) processor 70, 72, 74, 76, 78, 80 (making up the respective directional units 69, 71, 73, 75, 77, 79. As such, the present system 10 may include first and second X-axis HRTF processors 70, 72 respectively associated with the first and second X-axis cameras 46, 48, first and second Y-axis HRTF processors 74, 76 respectively associated with the first and second Y-axis cameras 50, 52, and first and second Z-axis HRTF processors 78, 80 respectively associated with the first and second Z-axis cameras 54, 56.

The individually captured, discrete audio channel signals are run though the HRTF virtual surround processors. The output after the virtual surround processor is a very believable 3-D sonic picture wherein the audio contains the cues that create sonic virtual reality in perception to our ears whether listened to via stereo loudspeakers (when seated correctly in front of and equidistant to them) or via stereo headphones when the headphones are worn correctly on the correct ears with the correct Left/Right channel assignment. This virtual surround three-dimensional audio signal can then be recorded, saved, broadcast, streamed, etc. It works very well with all existing stereo infrastructures worldwide and reduces the complexity required to achieve three-dimensional virtual surround sound for many more people.

As those skilled in the art will appreciate, an HRTF processor characterizes how an individual's ear receives a sound from a point in space. In accordance with the present invention each HRTF processor may include a pair of HRTF processors which synthesize the effect of a binaural sound coming from a particular area in space. As will be appreciated based upon the following disclosure the audio data received and processed by the HRTF processor identifies how a human would locate the sounds received by the multi-directional array of audio sensors in a three-dimensional space, that is, the distance from which the sound is coming, whether the sound is above or below the ears of the individual, whether the sound is in the front or rear of the individual and whether the sound is to the left or the right of the individual.

When implementing a system, it can be appreciated that if one set of “audio directional unit” signals are passed through a single set of HRTF processors, 3D audio may be achieved. If audio directional units are switched from one perspective to another before the individual HRTF processors described above, and summarily this alternative directional unit is passed through the same set of HRTF processors as the original directional unit, 3D audio may also be achieved.

The HRTF processors 70, 72, 74, 76, 78, 80 generate signals relating to how the left ear (left audio signal) and the right ear (right audio signal) of an individual would spatially perceive the sound being captured by the audio sensors 18, 20, 22, 24, 26, 28 when the individual is facing in the direction of as specific associated camera 46, 48, 50, 52, 54 56. The left and right signals generated by each of the HRTF processors 70, 72, 74, 76, 78, 80 are transmitted to a virtual reality switcher 82, which functions in a manner similar to the Kolor® AUTOPANO® software, etc.

Since the cameras 46, 48, 50, 52, 54, 56 are directionally aligned with the various audio sensors 18, 20, 22, 24, 26, 28 via the directional units 69, 71, 73, 75, 77, 79, the audio signals processed by the HRTF processors 70, 72, 74, 76, 78, 80 may be combined with the video information generated by the same directionally oriented camera 46, 48, 50, 52, 54, 56. With this in mind, it is appreciated the devices may be free to move anywhere in space and in any direction as long as the individual audio sensors 18, 20, 22, 24, 26, 28 remain tied to the individual chosen camera perspective to which it has been originally assigned (just as one's head can move in any direction, so can the apparatus in order to achieve any effect or outcome that should be desired by the operator). As such, video information generated by the first and second X-axis cameras 46, 48 is linked with the first and second X-axis HRTF processors 70, 72 (that is, directional units 69, 71), video information generated by the first and second Y-axis cameras 50, 52 is linked with the first and second Y-axis HRTF processors 74, 76 (that is, directional units 73, 75), and video information generated by the first and second Z-axis cameras 54, 56 is linked with the first and second Z-axis HRTF processors 78, 80 (that is, directional units 77, 79).

Multi-channel video data is currently handled by either stitching or editing software which switches or morphs the information from one camera to the information from the next cameras by fading or combining or mixing signals together in a seamless manner so that it becomes almost imperceptible to the viewer which camera was shooting the information to begin with. The same may happen with audio whereby the audio information may be combined, morphed, mixed or smoothed together based on the perspectives that the operator requires for the production and may match the video perspective. If in a security environment, an automatic video switcher or manual video selector is used, the audio information would switch with the video information to remain intact perspective-wise.

According to an embodiment, the virtual reality switcher 82 translates the signals generated by the first and second X-axis HRTF processors 70, 72, the first and second Y-axis HRTF processors 74, 76 and the first and second Z-axis HRTF processors 78, 80, as well as the signals generated by the cameras 46, 48, 50, 52, 54, 56. The translated signals are assigned to a directional matrix 34 that stores the sound and video signals in relation to their perceived location relative to an individual. As such, the directional matrix stores the sound as it corresponds with a similarly directed camera.

The video stitching software or editor is where the video meets the audio. Additionally, each processed stereo audio unit can be captured by its associated individual camera or in the future to a central audio/video memory processor area to be manipulated further down the signal chain. It also contemplated processing of the audio may be affected by positional sensors located on a person or connected to the captured device. In accordance with an embodiment the audio information from individual cameras may remain directly tied with the camera to which it is associated. This may keep the information in sync with the perspective of the camera and make it easy to use on currently available editing systems; be it virtual reality stitching software or more traditional video editing or security monitor switching equipment. It is, however, contemplated a central recorder in a discrete system may capture all audio and video information simultaneously. Such a system may allow for audio information to be recorded individual and discretely alongside the video information for future use. There may be a mechanism for capturing multi-channel audio alongside multi-channel video in a central recording system for expansion later on in the production or process chain. The virtual reality processing can be either before this internal recorder or after it.

Once the audio information is processed and stored by the virtual reality switcher 82 it may be selectively retrieved for use in conjunction with the creation of a virtual reality environment. In accordance with a preferred embodiment this is done by combining the audio with video using a virtual reality production system.

The virtual reality production system may retrieve the information from the directional audio matrix generated by the virtual reality perspective switch to properly assign sounds to the ears of an individual based upon the individual's head position while using the virtual reality production system. When the user turns his or her head the individual's perspective changes and the direction from which he or she would perceive sounds changes. Because the recorded sound is stored within a matrix defined by relative individual positions when the sound was recorded, that is, left or right emanating sound, central front or central rear emanating sounds, and/or upper and lower emanating sounds, the recorded sound may be matched with the current positional information relating to the head of the user while using the virtual reality production system to ensure the directionality of the sound is properly matched.

With the foregoing in mind, the present invention re-creates a compelling and believable three-dimensional space allowing individuals to virtual visiting a distant planet or go on an exotic virtual holiday to experience both three-dimensional sights and sounds.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A method for capturing and recording audio suitable for subsequent reproduction in a virtual reality environment, the method comprising:
recording audio input from a plurality of audio sensors arranged in a three-dimensional space; and
for each of the audio sensors, associating and storing spatial position information with the recorded audio input which corresponds to the position of the audio sensors in the three-dimensional space to create at least one audio recording.

2. The method of claim 1, further comprising associating and storing direction information that associates the recorded audio input to correspond with the direction of a visual sensor associated to the recorded audio that has been received.

3. The method of claim 2, further comprising associating the recorded audio input from the plurality of audio sensors with recorded video input from at least one video camera such that the recorded audio input may be synchronized in time with the recorded video input.

4. The method of claim 2, wherein the position information and the direction information of each audio sensor is associated and stored relative to the position and direction information of a video camera.

5. The method of claim 1, wherein the at least one audio recording comprises one audio recording for all of the audio sensors.

6. The method of claim 1, wherein the at least one audio recording comprises one audio recording for each of the audio sensors.

7. The method of claim 3, wherein the number of audio recordings is less than or equal to the number of video cameras.

8. A method for reproducing audio in an environment comprising:
receiving information identifying a listener's head position and head orientation in a three-dimensional space;
processing the at least one audio recording, in which the processing comprises, for each of the listener's left ear and the listener's right ear, synthesizing audio corresponding to audio the listener's ears would be receiving from the at least one audio recording at the listener's head position and head orientation in the three-dimensional space; and
outputting the synthesized audio to the listener's left ear and the listener's right ear through at least one audio playback device.

9. The method of claim 8, further comprising synchronizing in time the output of the synthesized audio with video output being displayed to the listener.

10. A system for recording audio suitable for subsequent reproduction in an environment, the system comprising:
a plurality of audio sensors arranged in a three-dimensional space, each audio sensor for receiving audio input;
a processor for executing stored computer-readable instructions which when executed, cause the processor to receive and store received audio from any of the plurality of audio sensors as at least one audio recording, and for each audio recording, cause the processor to associate and store position information which corresponds to the position of the audio sensor in the three-dimensional space, and associate and store direction information which corresponds to the direction from which the recorded audio has been received.

11. The system of claim 10, further comprising computer-readable instructions which when executed by a processor associates the recorded audio input from the plurality of audio sensors with recorded video input from at least one video camera such that the recorded audio input may be synchronized in time with the recorded video input.

12. The system of claim 10, wherein the at least one audio recording comprises one audio recording for all of the audio sensors.

13. The system of claim 10, wherein the at least one audio recording comprises one audio recording for each of the audio sensors.

14. The system of claim 11, wherein the number of audio recordings is less than or equal to the number of video cameras.

15. The system of claim 10, in which the system for recording audio for subsequent reproduction in a virtual realty environment operates in conjunction with a system for recording video for subsequent reproduction in a virtual realty environment.

16. The system of claim 15, wherein at least one of the plurality of audio sensors is coupled to at least one video camera.

17. The system of claim 15, wherein at least one of the plurality of audio sensors and at least one video camera is detachably coupled to a mounting frame.

18. The system of claim 15, wherein the plurality of audio sensors is coupled to one or more video cameras.

19. The system of claim 15, wherein the plurality of audio sensors and a plurality of video cameras are detachably coupled to a mounting frame.

20. A system for reproducing audio in a virtual reality environment, the system comprising:
at least one audio playback device capable of generating sound from synthesized audio;
a processor comprising computer-readable instructions which when executed, cause the processor to:
receive information identifying a listener's head position and head orientation in a three-dimensional space;
process one or more audio recordings each having associated position information which corresponds to the position the audio was recorded from in the three-dimensional space and associated direction information which corresponds to the direction from which the recorded audio was received,
in which the processing comprises, for each of the listener's left ear and the listener's right ear, synthesizing audio corresponding to audio the listener's ears would receive from the one or more audio recordings at the listener's head position and head orientation in the three-dimensional space; and
outputting the synthesized audio to the listener's left ear and the listener's right ear through the at least one audio playback device.

21. The system of claim 20, the processor further comprising computer-readable instructions which when executed, cause the processor to synchronize in time the output of the synthesized audio with video output being displayed to the listener.
